(19) United States
(12) Patent Application Publication
(10) Pub. No.: US 2026/0172415 A1
(43) Pub. Date: Jun. 18, 2026

(54) GATEWAY, BODY BUILDER CONTROL SYSTEM, AND A METHOD THEREOF

(71) Applicants: HYUNDAI MOTOR COMPANY, Seoul (KR); KIA CORPORATION, Seoul (KR)

(72) Inventor: Dae Hyun Kim, Hwaseong-si (KR)

(73) Assignees: HYUNDAI MOTOR COMPANY, Seoul (KR); KIA CORPORATION, Seoul (KR)

(21) Appl. No.: 19/214,716

(22) Filed: May 21, 2025

(30) Foreign Application Priority Data
Dec. 13, 2024 (KR) 10-2024-0186419

(51) Int. Cl. H04L 9/40; H04L 12/40; H04L 12/66

(52) U.S. Cl. CPC H04L 63/0823; H04L 12/40; H04L 12/66; H04L 2012/40215

(57) ABSTRACT

A gateway included in a vehicle is configured to receive a body builder certificate generated by a second server configured to control the vehicle. The body builder certificate is generated based on a certificate generation request of a first server configured to perform control of a body builder. The gateway is configured to determine a control area network (CAN) identifier included in the body builder certificate, based on performing verification of the body builder certificate. The gateway is further configured to transmit the body builder certificate to a target controller associated with the CAN identifier, among controllers included in the vehicle.

### CROSS-REFERENCE TO RELATED APPLICATION

This application claims the benefit of and priority to Korean Patent Application No. 10-2024-0186419, filed in the Korean Intellectual Property Office on Dec. 13, 2024, the entire contents of which are hereby incorporated herein by reference.

### TECHNICAL FIELD

The present disclosure relates to a gateway, a body builder control system, and a method thereof, and more particularly, relates to technologies for communication between a vehicle and a controller of a body builder.

### BACKGROUND

A body builder control scheme is generally a scheme for operating a body builder device, which is an external device outside a vehicle. The body builder device may be operated based on information such as a speed or revolutions per minute (RPM) of the vehicle. However, recently, there has been an increase in cases in which a body builder device controls an internal function of the vehicle, such as an ON/OFF state and RPM adjustment of the engine of the vehicle. Thus, the vehicle may be affected via an external instruction from a body builder device.

In the above-mentioned structure, if a controller of the body builder device is hacked or an abnormal instruction is received, the operation of the vehicle itself may change to an unexpected scheme. There is a potential risk factor in that this may lead to a fatal accident in which a vehicle driver and/or a pedestrian on the road may be harmed.

### SUMMARY

The present disclosure has been made to solve the above-mentioned problems occurring in the prior art while advantages achieved by the prior art are maintained intact.

Embodiments of the present disclosure provide a technology for an authentication system for secure communication in which a body builder company predefines data available in communication with a vehicle, and only the authenticated company uses the data to communicate with the vehicle. Furthermore, embodiments of the present disclosure provide a technology for making a configuration such that a user selects and enables a desired function package if necessary to prevent access to an unnecessary function and allow a controller of a body builder to access only the necessary function.

Aspects of the present disclosure provide a gateway, a body builder control system, and a method for determining a body builder certificate generated by a second server configured to control a vehicle that includes the gateway, where the body builder certificate is generated based on a certificate generation request of a first server configured to perform control of a body builder, to ensure secure communication with an external device outside a vehicle. The gateway, the body builder control system, and the method may thus limit unnecessary access to an internal function of the vehicle, thereby reinforcing security and ensuring safety of the vehicle and the driver.

The technical problems to be solved by the present disclosure are not limited to the aforementioned problems. Other technical problems not mentioned herein should be more clearly understood from the following description by those having ordinary skill in the art to which the present disclosure pertains.

According to an aspect of the present disclosure, a gateway is provided. The gateway includes a memory storing computer-readable instructions and a processor configured to execute the computer-readable instructions. The processor is configured to receive a body builder certificate generated by a second server configured to control a vehicle that includes the gateway, where the body builder certificate is generated based on a certificate generation request of a first server configured to perform control of a body builder. The processor is also configured to determine routing based on a control area network (CAN) identifier included in the body builder certificate, based on performing verification of the body builder certificate. The processor is additionally configured to transmit the body builder certificate to a target controller associated with the CAN identifier, among controllers included in the vehicle.

In an embodiment, the processor may be configured to determine whether the body builder certificate is a certificate generated by the second server, based on receiving the body builder certificate. The processor may also be configured to determine whether the target controller associated with the CAN identifier included in the body builder certificate is included in the vehicle.

In an embodiment, the processor may be configured to transmit a data packet to the target controller, based on routing information obtained from a routing table based on the CAN identifier. The processor may also be configured to determine the body builder certificate as a valid certificate, based on receiving an approval request from the target controller.

In an embodiment, the processor may be configured to perform the verification of the body builder certificate, based on identifying the body builder certificate as the body builder that is mounted on the vehicle. The processor may also be configured to transmit the body builder certificate to the target controller, based on the CAN identifier included in the body builder certificate. The processor may further be configured to transmit a state data packet received from the target controller to a controller of the body builder.

According to another aspect of the present disclosure, a body builder control system is provided. The body builder control system includes a gateway, a first server configured to perform control of a body builder, and a second server configured to control a vehicle that includes the gateway. The gateway is configured to receive a body builder certificate generated by the second server, based on a certificate generation request of the first server. The gateway is also configured to determine routing based on a control area network (CAN) identifier included in the body builder certificate, based on performing verification of the body builder certificate. The gateway is additionally configured to transmit the body builder certificate to a target controller associated with the CAN identifier, among controllers included in the vehicle.

In an embodiment, the first server may be configured to transmit the certificate generation request to the second server to request control of the body builder mounted to the vehicle. The second server may be configured to identify a control item included in the certificate generation request, based on receiving the certificate generation request from the first server. The second server may be configured to generate the body builder certificate to include the control item and the CAN identifier associated with the target controller determined based on the control item.

In an embodiment, the second server may be configured to perform a digital signature and encryption of the body builder certificate and transmit the body builder certificate, the digital signature and the encryption of which are performed, to the first server.

In an embodiment, the first server may be configured to receive the body builder certificate generated by the second server and apply the body builder certificate to a controller of the body builder, such that the body builder certificate is transmitted to the gateway at a time point when the body builder is mounted on the vehicle.

According to another aspect of the present disclosure, a body builder control method is provided. The body builder control method includes receiving a body builder certificate generated by a second server, where the body builder certificate is generated based on a certificate generation request of a first server. The body builder control method also includes determining routing based on a control area network (CAN) identifier included in the body builder certificate, based on performing verification of the body builder certificate. The body builder control method additionally includes transmitting the body builder certificate to a target controller associated with the CAN identifier, among controllers included in a vehicle.

In an embodiment, determining routing based on the CAN identifier may include: determining whether the body builder certificate is a certificate generated by the second server, based on receiving the body builder certificate; and determining whether the target controller, associated with the CAN identifier included in the body builder certificate, is included in the vehicle.

In an embodiment, determining routing based on the CAN identifier may include: transmitting a data packet to the target controller, based on routing information obtained from a routing table based on the CAN identifier; and determining the body builder certificate as a valid certificate, based on receiving an approval request from the target controller.

In an embodiment, determining routing based on the CAN identifier may include: performing the verification of the body builder certificate, based on determining that the body builder certificate corresponds to the body builder mounted on the vehicle; transmitting the body builder certificate to the target controller, based on the CAN identifier included in the body builder certificate; and transmitting a state data packet received from the target controller to a controller of the body builder.

In an embodiment, the body builder control method may further include transmitting the certificate generation request to the second server to request control of a body builder mounted to the vehicle. The body builder control method may also include identifying a control item included in the certificate generation request, based on receiving the certificate generation request from the first server. The body builder control method may additionally include generating the body builder certificate to include the control item and the CAN identifier associated with the target controller determined based on the control item.

In an embodiment, the body builder control method may further include: performing a digital signature and encryption of the body builder certificate; and transmitting the body builder certificate, the digital signature and the encryption of which are performed, to the first server.

In an embodiment, the body builder control method may further include: receiving the body builder certificate generated by the second server; and applying the body builder certificate to a controller of the body builder, such that the body builder certificate is transmitted to a gateway at a time point when the body builder is mounted on the vehicle.

### BRIEF DESCRIPTION OF THE DRAWINGS

The above and other objects, features, and advantages of the present disclosure should be more apparent from the following detailed description taken in conjunction with the accompanying drawings, in which:

FIG. 1 is a drawing illustrating a block diagram of a body builder control system, according to an embodiment of the present disclosure;

FIG. 2 is a flowchart for describing an operation of a gateway, according to an embodiment of the present disclosure;

FIG. 3 is a drawing illustrating a communication flow diagram between servers, in a body builder control system, according to an embodiment of the present disclosure;

FIG. 4 is a drawing illustrating a communication flow diagram between a body builder and a gateway, in a body builder control system, according to an embodiment of the present disclosure;

FIG. 5 is a drawing illustrating an example of a control item included in a body builder certificate, according to an embodiment of the present disclosure;

FIG. 6 is a drawing illustrating an interface for a body builder certificate generation request, according to an embodiment of the present disclosure;

FIG. 7 is a drawing illustrating a body builder certificate transmission flow diagram between a body builder and a gateway, in a body builder control system, according to an embodiment of the present disclosure;

FIGS. 8A and 8B are drawings illustrating a communication flow diagram according to whether there is a body builder certificate, in a body builder control system, according to an embodiment of the present disclosure;

FIG. 9 is a flowchart for describing a body builder control method, according to an embodiment of the present disclosure; and

FIG. 10 is a drawing illustrating a computing system associated with a body builder control method, according to an embodiment of the present disclosure.

With regard to description of drawings, the same or similar components are designated by the same or similar reference numerals.

### DETAILED DESCRIPTION

Hereinafter, embodiments of the present disclosure are described in detail with reference to the accompanying drawings. In adding the reference numerals to the components of each drawing, it should be noted that the identical components are designated by the identical numerals even when the components are displayed on different drawings. Further, in describing the embodiment of the present disclosure, where it was determined that a detailed description of well-known features or functions would unnecessarily obscure the gist of the present disclosure, the detailed description thereof has been omitted.

Various embodiments of the present disclosure are described with reference to the accompanying drawings. However, it should be understood that this is not intended to limit the present disclosure to specific implementation forms. Rather, the present disclosure includes various modifications, equivalents, and/or alternatives of embodiments of the present disclosure. With regard to description of drawings, similar components may be marked by similar reference numerals.

In describing components of embodiments of the present disclosure, the terms first, second, A, B, (a), (b), and the like may be used herein. These terms are only used to distinguish one component from another component. These terms do not limit the corresponding components irrespective of the order or priority of the corresponding components. Furthermore, unless otherwise defined, all terms including technical and scientific terms used herein have the same meaning as generally understood by those having ordinary skill in the art to which the present disclosure pertains. Such terms as those defined in a generally used dictionary should be interpreted as having meanings equal to the contextual meanings in the relevant field of art, and should not be interpreted as having ideal or excessively formal meanings unless clearly defined as having such in the present disclosure. Terms such as “first”, “second”, “1st”, “2nd”, or the like used in the present disclosure may be used to refer to various components regardless of the order and/or the priority and to distinguish one component from another component. These terms do not limit the components. For example, a first user device and a second user device indicate different user devices, irrespective of the order and/or priority. Without departing the scope of the present disclosure, a first component may be referred to as a second component, and similarly, a second component may be referred to as a first component.

In the present disclosure, the expressions such as “have”, “may have”, “include” and “comprise”, or “may include” and “may comprise” indicate existence of corresponding features (e.g., components such as numeric values, functions, operations, or parts), but do not exclude presence of additional features.

It should be understood that when a component (e.g., a component) is referred to as being “(operatively or communicatively) coupled with/to” or “connected to” another component (e.g., a second component), the component may be directly coupled with/to, or connected with/to, the other component or one or more intervening components (e.g., a third component) may be present. In contrast, when a component (e.g., a first component) is referred to as being “directly coupled with/to” or “directly connected to” another component (e.g., a second component), it should be understood that there is no intervening component (e.g., a third component).

In the present disclosure, when a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function. Each component, controller, device, element, module, apparatus, gateway, server, and the like may separately embody or be included with a processor and a memory, such as a non-transitory computer readable media, as part of the apparatus.

According to the situation, the expression “configured to” used in the present disclosure may be used interchangeably with, for example, the expression “suitable for”, “having the capacity to”, “designed to”, “adapted to”, “made to”, or “capable of”.

The term “configured to” as used herein does not necessarily mean “specifically designed to” in hardware. The expression “a device configured to” may mean that the device is “capable of” operating together with another device or other parts. For example, a “processor configured to perform A, B, and C” may mean a generic-purpose processor (e.g., a central processing unit (CPU) or an application processor) which may perform corresponding operations by executing one or more software programs on a dedicated processor (e.g., an embedded processor) for performing a corresponding operation or a memory device. Terms used in the present disclosure are used to describe specified embodiments and are not intended to limit the scope of the present disclosure. The terms of a singular form may include plural forms unless the context clearly indicates otherwise. All the terms used herein, including technical or scientific terms, may have the same meaning that is generally understood by a person having ordinary skill in the art to which the present disclosure pertains. It should be further understood that terms that are defined in a dictionary and commonly used should also be interpreted as is customary in the relevant related art and not in an idealized or overly formal manner unless expressly so defined herein in various embodiments of the present disclosure. In some cases, even if terms are defined in the disclosure, the terms may not necessarily be interpreted to exclude other embodiments of the disclosure.

In the present disclosure, the expressions “A or B”, “at least one of A or/and B”, or “one or more of A or/and B”, and the like may include any and all combinations of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included. Furthermore, in describing an embodiment of the present disclosure, each of such phrases as “A or B”, “at least one of A and B”, “at least one of A or B”, “A, B, or C”, “at least one of A, B, and C”, “at least one of A, B, or C”, and “at least one of A, B, or C, or any combination thereof” may include any one of, or all possible combinations of the items enumerated together in a corresponding one of the phrases. For example, the phrase such as “at least one of A, B, or C, or any combination thereof” may include “A”, “B”, or “C”, or “AB” or “ABC”, which is a combination thereof.

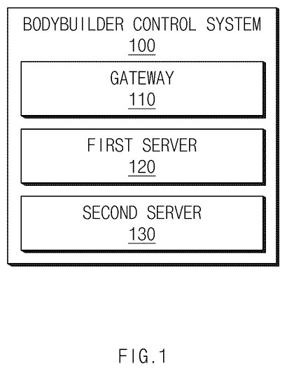

FIG. 1 is a drawing illustrating a block diagram of a body builder control system according to an embodiment of the present disclosure.

A vehicle body builder control system 100 according to an embodiment may include a gateway 110, a first server 120, and a second server 130.

The gateway 110 may be a gateway for managing communication between a vehicle and a body builder and/or a controller of the body builder. The gateway 110 may perform identification, verification, and routing of a body builder certificate. In an embodiment, the gateway 110 may identify and verify a body builder certificate generated by the second server 130 based on a certificate generation request transmitted from the first server 120. In this process, the gateway 110 may determine routing based on a CAN identifier included in the body builder certificate and may transmit the body builder certificate to a target controller in the vehicle. The gateway 110 may deliver an instruction (or a data packet) received from the controller of the body builder to the inside (i.e., the target controller) of the vehicle, based on the result of verifying the body builder certificate, to perform a security reinforcement function for protecting a vehicle system from an external attack or unauthorized access.

The first server 120 may be an entity for performing control of the body builder. The first server 120 may manage a request to generate the body builder certificate and may generate a control command associated with the body builder. For example, if a body builder company accesses the vehicle system (e.g., the target controller), the first server 120 may check whether there is a certificate of the body builder company and may request the second server 130 to generate the certificate if the certificate is required. Accordingly, the first server 120 may effectively manage an access right of the body builder and may provide security in allowing only the authenticated body builder and/or the authenticated body builder company to securely access the vehicle system. The first server 120 may provide a basis capable of providing various vehicle services, via the authentication of the body builder and the communication control.

The second server 130 may manage control of the vehicle including the gateway 110 and may generate and manage the body builder certificate. In response to receiving the certificate generation request from the first server 120, the second server 130 may generate the body builder certificate based on information of the body builder company and may transmit the generated body builder certificate to the first server 120. The second server 130 may store information associated with a qualification of the body builder company. The second server 130 may thus issue and manage a certificate and may provide a basis (i.e., the body builder certificate) capable of checking whether an external device for accessing the vehicle system is reliable. Furthermore, the second server 130 may link a CAN identifier of each vehicle with the body builder certificate and may grant an access right to only a specific body builder, thus providing security of the vehicle system.

In general, the body builder (or vehicle body builder) may refer to an external company for installing or remodeling an additional device (e.g., a special or custom device) in the vehicle itself to allow the additional device to perform a specific function. For example, the body builder may include companies for adding a cargo space to a truck or performing work for remodeling a vehicle for special use, such as a fire truck, an ambulance, or a cleaning truck. The body builder may change or adapt a standard vehicle provided by a vehicle manufacturer to be suitable for special use to suit the needs of a user. The body builder may generally achieve the change or adaptation of the vehicle via the work of remodeling the appearance of the vehicle or an internal system of the vehicle.

The body builder may interact with a control system of a specific vehicle to control a vehicle function and/or may transmit a command to control the vehicle to perform a specific operation. For example, there may be a need for a fire truck to operate a water pump or control a fire-fighting related special device. Accordingly, there may be a need for the controller of the body builder to securely communicate with the vehicle. However, if such communication is abused by external hacking or unauthorized access, because it is capable of posing a serious danger to safety of the vehicle and a passenger, the body builder company should be a company authenticated by the manufacturer of the vehicle and should perform access in only an authenticated method for secure communication with the vehicle.

For convenience of description in the specification, the body builder may refer to an additional device installed in the vehicle itself as well as a company for installing or remodeling the additional device in the vehicle itself. In other words, the body builder may be the additional device installed in the vehicle itself and may further include a controller of the body builder, which may communicate with the vehicle.

The body builder certificate may be a digital certificate issued to a specific body builder company by a vehicle manufacturer or a certificate authority. The body builder certificate may comprise an electronic means for verifying that a controller of a corresponding body builder has a qualification capable of securely accessing the vehicle system. The body builder certificate may be generated in the process of verifying the legitimacy of the body builder company and may be used as an important element for reinforcing security in communicating with the vehicle system. The body builder certificate may include unique identification information of the body builder company, a certificate issue date, a validity period, and/or information about accessible vehicle control elements (e.g., a control item, a target controller, or the like). For example, controller area network (CAN) identifiers associated with devices capable of being controlled by the controller of the specific body builder may be specified in the body builder certificate. As a result, the body builder certificate may ensure that the controller of the body builder accesses only a target controller or device of the vehicle. The body builder certificate may be used to block unnecessary access to a vehicle control system and may ensure that an authorized task for only a specific function can be performed.

The body builder certificate may be issued and managed by the second server 130 of the vehicle manufacturer and may be generated according to a certificate request of the first server 120. The gateway 110 may verify the body builder certificate and may determine routing, such that an instruction of the body builder is delivered to the target controller in the vehicle according to the information included in the body builder certificate. The body builder certificate may be a security measure for securely maintaining communication between the controller of the body builder and the target controller included in the vehicle. The body builder certificate may be used to allow the body builder company (e.g., the first server 120) approved by the vehicle manufacturer (e.g., the second server 130) to access the vehicle system in a secure manner and protect the vehicle and the driver from hacking or unauthorized access.

The gateway 110 may include a processor, a memory including computer-readable instructions, and a communication device. The processor may execute the computer-readable instructions and may control at least one other component (e.g., a hardware or software component) connected with the processor. In addition, the processor may perform a variety of data processing or computation. For example, the processor may store the body builder certificate in the memory.

In an embodiment, the processor may perform all operations performed by the gateway 110. Therefore, for convenience of description in the specification, the operation performed by the gateway 110 is mainly described as an operation performed by the processor. Furthermore, for convenience of description in the specification, the processor is mainly described as, but not limited to, one processor. For example, the gateway 110 may include at least one processor. For example, each of the at least one processor may perform operations associated with managing communication between the vehicle and the body builder and/or the controller of the body builder and performing identification, verification, and routing of the body builder certificate.

The memory may store temporarily and/or permanently various pieces of data and/or information required to manage communication between the vehicle and the body builder and/or the controller of the body builder and perform identification, verification, and routing of the body builder certificate. For example, the memory may store the body builder certificate.

The communication device may enable communication between the gateway 110 and the controller of the body builder. For example, the communication device may include one or more components for performing communication between the gateway 110 and the controller of the body builder. For example, the communication device may include a short range wireless communication unit, a microphone, or the like. The short range wireless communication unit ma use a short range communication technology such as, but not limited to, a wireless LAN (Wi-Fi), Bluetooth, ZigBee, Wi-Fi Direct (WFD), ultra-wideband (UWB), infrared data association (IrDA), Bluetooth low energy (BLE), near field communication (NFC), or the like.

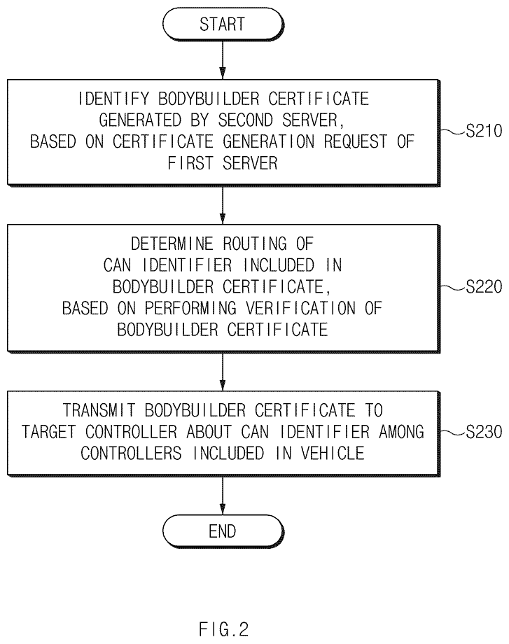

FIG. 2 is a flowchart for describing operations of a gateway according to an embodiment of the present disclosure.

In an operation S210, a gateway (e.g., the gateway 110 of FIG. 1) according to embodiment may identify a body builder certificate generated by a second server (e.g., the second server 130 of FIG. 1) for controlling a vehicle including the gateway and managing the body builder certificate, based on a certificate generation request of a first server (e.g., the first server 120 of FIG. 1) for performing control of a body builder.

In an operation S220, the gateway may determine routing based on a controller area network (CAN) identifier included in the body builder certificate, based on performing verification of the body builder certificate. In various examples, the gateway may verify a plurality of certificates as well as one body builder certificate. The gateway may verify a separate certificate for an external device or a program used by a specific body builder together as well as the specific body builder, thus verifying a plurality of certificates, such that only the authenticated device participates in controlling the body builder.

The CAN identifier may refer to a unique identifier of a data frame transmitted over a CAN in the vehicle. Various electronic controllers (ECUs) in the vehicle may communicate over the CAN and may specify a specific control device or function on the network, because each data frame has a unique ID. The CAN identifier may include an identifier, such as 0x748, 0x562, or 0x981, and may be used as a unique ID referring to a specific function or a control command.

The routing may be a process of determining a destination controller (e.g., a target controller) for the gateway to transmit specific data on the CAN and setting a data frame to move along a correct path. The gateway may determine to which controller the instruction is to be delivered, depending on the CAN identifier identified via the body builder certificate.

As an example, if the gateway verifies the body builder certificate and then receives an instruction including the CAN identifier, 0x748, the instruction may be routed to an ECU (e.g., a target controller) for controlling RPM. As another example, an instruction including the CAN identifier, 0x562, may be routed to a controller for controlling an engine ON/OFF function and an instruction of the identifier, 0x981, may be delivered to a controller for controlling a power take-off (PTO) ON/OFF function.

In an operation S230, the gateway may transmit the body builder certificate to a target controller associated with the CAN identifier among controllers included in the vehicle.

The target controller may be a destination node or a destination controller for finally receiving the CAN identifier identified by the body builder certificate to perform a specific function among various control systems of the vehicle and executing a command. The target controller may be an element for performing a specific control function in the vehicle, which may illustratively take charge of a function, such as engine control, PTO control, or RPM adjustment.

The CAN identifier included in the body builder certificate may be an element for determining whether a data frame (or a data packet) paired with the CAN identifier is able to be transmitted to the target controller, via the routing process of the gateway. The gateway may perform routing such that the data frame (or the data packet) having the identifier (or paired with the identifier) is delivered to the target controller, depending on the CAN identifier identified and/or checked based on the body builder certificate.

For example, if the CAN identifier, 0x748, is included in the body builder certificate, a data packet (or an instruction) associated with the function of controlling RPM and paired with the CAN identifier 0x748 may be transmitted to the target controller for taking charge of RPM control through the routing process of the gateway. If the CAN identifier, 0x562, is associated with the engine ON/OFF function, the gateway may route a data packet paired with the CAN identifier 0x562 to the target controller for taking charge of engine control and may ensure that the instruction (or the data packet) is able to be securely executed.

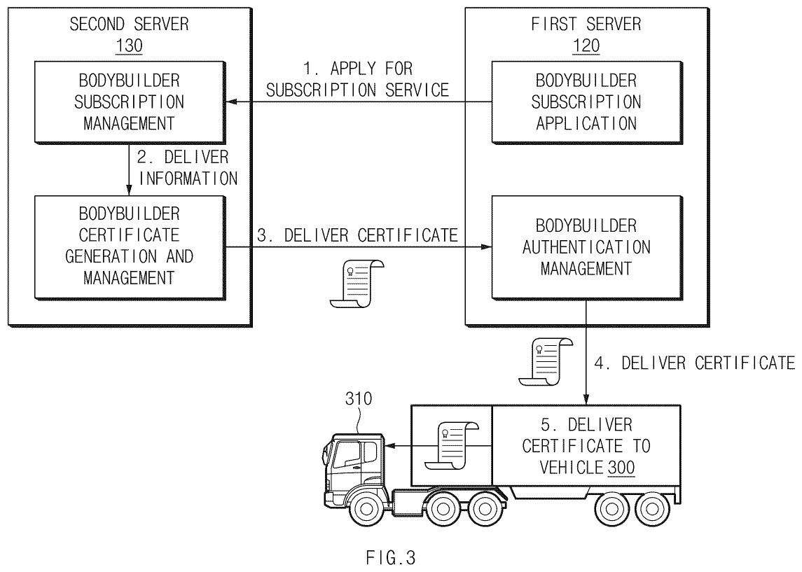

FIG. 3 is a drawing illustrating a communication flow diagram between servers, in a body builder control system according to an embodiment of the present disclosure.

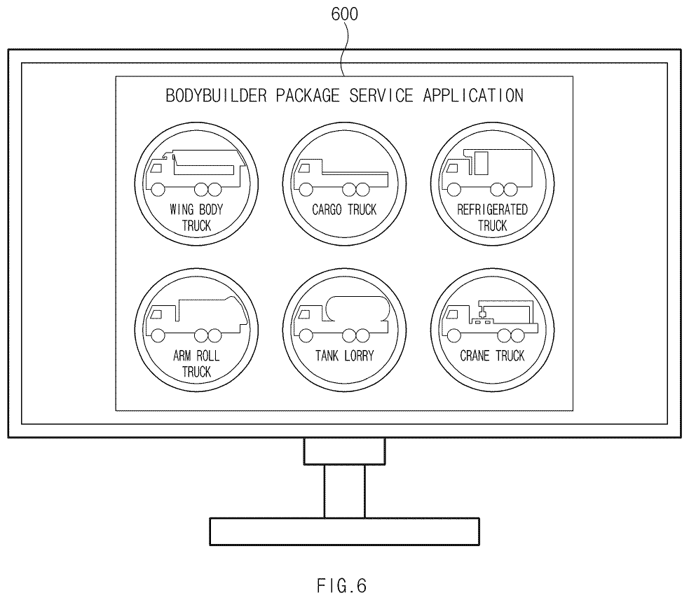

Referring to FIG. 3, the first server 120 and the second server 130 may perform communication with each other to generate a body builder certificate. For example, the first server 120 may transmit a certificate generation request to the second server 130 to request control of (e.g., to transmit a control data packet for control of) a body builder 300 in a vehicle 310. The certificate generation request may be a subscription service request in terms of the first server 120. A user terminal that accesses the first server 120 may transmit the subscription service request via an interface shown in FIG. 6, for example.

For convenience of description in the specification, the certificate generation request and a subscription service application may be used for the same purpose and may operate as an interlinked process. For example, in communication between the first server 120 and the second server 130, the first server 120 may perform the subscription service application to receive the body builder certificate and the second server 130 may process the certificate generation request based on the subscription service application.

In an embodiment, the first server 120 may transmit the subscription service application to receive a certificate (i.e., the body builder certificate) necessary for control of the body builder 300 mounted on the vehicle 310 from the second server 130. The subscription service application may be an operation of requesting the right to control the body builder 300 connected with the vehicle 310 by the first server 120.

The second server 130 may identify a control item included in the certificate generation request, based on receiving the certificate generation request from the first server 120.

The certificate generation request transmitted to the second server 130 by the first server 120 may include various pieces of information associated with a function to be controlled by the body builder 300 after the body builder 300 accesses a vehicle system. In detail, the certificate generation request may include body builder identification information, a control item, a CAN identifier, a certificate validity period, a security key or encryption information, and an access restriction condition.

For example, the body builder identification information may include information about a body builder company, such as a unique ID, a company name, and a registration number of the body builder 300. The control item may be an item for defining a specific function to be controlled in the vehicle 310 by the body builder 300. For example, the control item may include a detailed item, such as engine ON/OFF, RPM control, or power take-off (PTO) function ON/OFF. The control items may be specified as the CAN identifiers and may embody a specific function in which an access right of the body builder 300 is limited. The CAN identifier may include identification information for allowing each control function in the vehicle to be divided in the CAN. The certificate validity period may be a period when the body builder certificate is valid. The certificate validity period may thus impose a limit such that a vehicle access right of the body builder 300 is valid during only a certain period. The security key or the encryption information may include a key or encryption information for reinforcing security of the certificate and may be used such that a third party other than the body builder to which the certificate is assigned does not copy or abuse the body builder certificate. The access restriction condition may include condition information for setting the control item to be enabled in only a specific situation or condition.

The second server 130 may generate the body builder certificate including the control item and the CAN identifier associated with the target controller specified in or otherwise associated with the control item. In an embodiment, the second server 130 may perform digital signature and encryption of the body builder certificate and may transmit the body builder certificate, the digital signature and the encryption of which are performed, to the first server 120.

The first server 120 may receive the body builder certificate generated by the second server 130 and may apply the body builder certificate to a controller of the body builder 300, such that the body builder certificate is transmitted to a gateway (e.g., the gateway 110 of FIG. 1) at a time point when the body builder 300 is mounted on the vehicle 310.

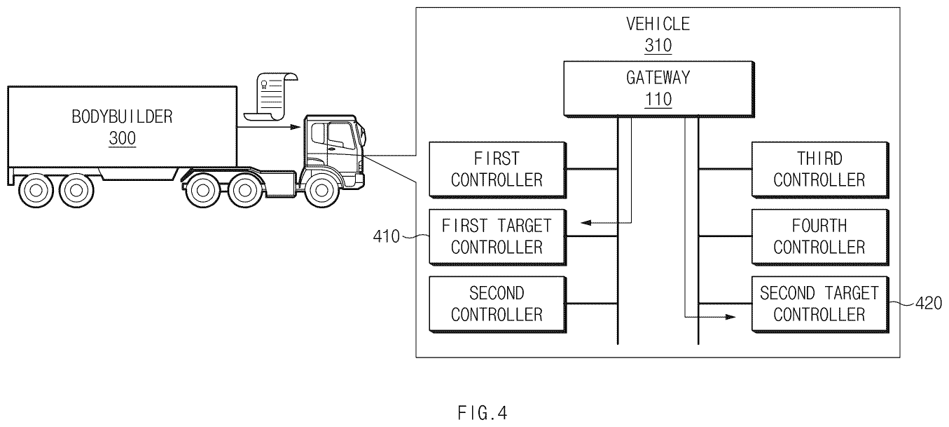

FIG. 4 is a drawing illustrating a communication flow diagram between a body builder and a gateway, in a body builder control system according to an embodiment of the present disclosure.

Referring to FIG. 4, the vehicle 310 may be coupled to the body builder 300. The vehicle 310 may include the gateway 110 and at least one controller (e.g., a first target controller 410 and a second target controller 420). The gateway 110 may be connected with each of the at least one controller for communication.

A controller of the body builder 300 may be a device for playing a key role in interacting with the vehicle 310 to manage the body builder 300 to be securely coupled and integrated with the vehicle 310. The controller of the body builder 300 may take charge of reception of a body builder certificate and delivery in a vehicle system and may implement an authentication procedure necessary when the body builder 300 communicates with the vehicle 310. For example, the controller of the body builder 300 may receive a body builder certificate from the first server 120. After receiving the body builder certificate, the controller of the body builder 300 may transmit the body builder certificate to the gateway 110 included in the vehicle 310. This process may be performed whenever the body builder 300 is connected with the vehicle 310. As a result, the gateway 110 may check whether the body builder 300 has an authorized certificate. Accordingly, the controller of the body builder 300 may provide secure and efficient communication between the vehicle 310 and the body builder 300.

The gateway 110 may determine whether the body builder certificate is a certificate generated by a second server 130, based on receiving the body builder certificate. The gateway 110 may identify whether a CAN identifier included in the body builder certificate and a target controller (e.g., the first target controller 410 and the second target controller 420) are included in the vehicle 310. The gateway 110 may transmit a data packet to the controller, depending on a routing table predetermined based on the CAN identifier. The gateway 110 may determine the body builder certificate as a valid certificate, based on receiving an approval request from the controller.

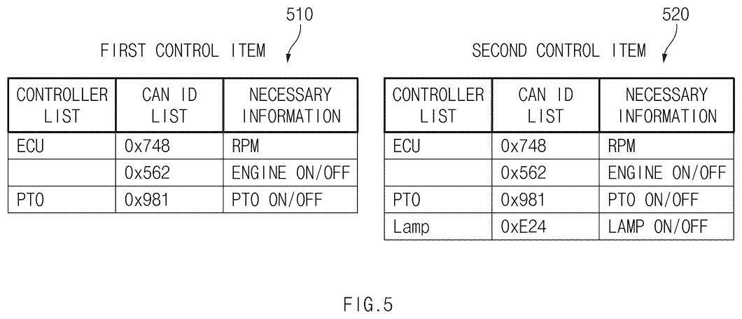

FIG. 5 is a drawing illustrating an example of a control item included in a body builder certificate.

Referring to FIG. 5, FIG. 5 illustrates a first control item 510 and a second control item 520. For example, the first control item 510 may indicate contents included in a first body builder certificate and the second control item 520 may indicate contents included in a second body builder certificate.

Each controller may perform a specific function in a vehicle system. A unique CAN identifier (i.e., a CAN ID) and necessary information therefor may be defined. The CAN identifier and the necessary information may play an important role in limiting a right necessary if a body builder interacts with a vehicle and a function range. A specific function in the vehicle may be identified via a specified CAN identifier for each controller and security may be reinforced such that only a control function approved via the body builder certificate may be accessed and controlled.

The CAN identifier is a unique identifier capable of being divided on a CAN for the specific function performed by each controller. For example, each of the CAN IDs included in the first control item 510 and the second control item 520 in FIG. 5 indicates a function associated with each controller. A CAN ID, 0x748, of an ECU in the first control item 510 indicates RPM control and a CAN ID, 0x562, indicates engine ON/OFF control. A power take-off (PTO) controller may be set to a CAN ID, 0x981, and a lamp controller may be added in the second control item 520 to indicate a lamp ON/OFF function using a CAN ID, 0x24.

Information necessary to perform the specific function may be defined in each controller and a specific control function in the vehicle may be enabled or controlled based on the information. For example, the ECU may need RPM information for RPM control and may need an engine control signal to change an engine ON/OFF state. The PTO controller may require a signal for controlling a PTO ON/OFF state and the lamp controller may require information for controlling an ON/OFF state of a lamp.

The necessary information shown in FIG. 5 may be linked to the CAN identifier and may be set to perform an appropriate function if necessary information is received in the vehicle system by the specific controller. For example, if the body builder wants to perform the specific function, the body builder may transmit a CAN data frame including the necessary information on the CAN. Data transmitted by the body builder may perform a task specified in a target controller through a routing process of a gateway.

FIG. 6 is a drawing illustrating an interface for a body builder certificate generation request, according to an embodiment.

As shown in FIG. 6, an interface 600 may be an interface capable of being accessed by a user via a first server, which may be configured to select and apply for various control items depending on necessity of each body builder. In an embodiment, the interface 600 may provide a menu for allowing the user to apply for a body builder package service and may include a predetermined control item depending on the specific use of the vehicle or may include a function for allowing a user to directly add a necessary control item and apply for the body builder package service.

For example, the interface 600 may provide the user with various body builder package options, such as a wing body truck, a cargo truck, a refrigerated truck, an arm roll truck, an LPG tank lorry, and a crane truck. The user may select control items necessary to perform a function of a body builder among body builder packages and may apply for the control items. Each package may include a specific control item necessary to perform the function of the body builder.

The interface 600 may display a detailed control item list (e.g., a CAN identifier and necessary information) for each body builder package. The user may review the item list and may apply for the package. For example, for a crane truck, as control items, such as an engine ON/OFF function necessary for crane operation, RPM control, and lamp ON/OFF, are predefined, the user may request a body builder certificate including a right for the control item via a first server.

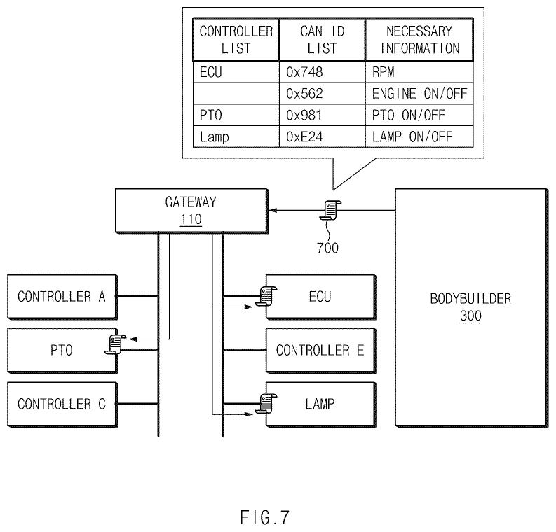

FIG. 7 is a drawing illustrating a body builder certificate transmission flow diagram between a body builder and a gateway, in a body builder control system according to an embodiment of the present disclosure.

Referring to FIG. 7, at a time point when the body builder 300 is installed in the vehicle 310, a controller of the body builder 300 may transmit a body builder certificate 700 to the gateway 110. In an embodiment, the controller of the body builder 300 may transmit the body builder certificate 700 to the gateway 110 at the time point when the body builder 300 is installed in the vehicle 310 and may set specific controllers in the vehicle 310 to securely receive a control command from an authenticated body builder. The body builder certificate 700 may include a right of access to each controller (e.g., an ECU, a PTO device, or a lamp) that perform various control functions in the vehicle 310.

If the body builder 300 is installed in the vehicle 310, the controller of the body builder 300 may transmit the body builder certificate 700 to the gateway 110. The body builder certificate 700 may define a specific control item capable of being controlled by the body builder 300 and may verify a right capable of accessing a specific controller in the vehicle 310 (e.g., a controller linked to a specific CAN ID in a CAN). The gateway 110 may receive the body builder certificate 700 and may check a control item and a CAN ID list included in the body builder certificate 700. The gateway 110 may verify whether control items operate within an authorized access right.

The gateway 110 may transmit the body builder certificate 700 to each target controller (e.g., the ECU, the PTO device, or the lamp) that performs its function, depending on the CAN ID list included in the body builder certificate 700. For example, if a CAN ID, 0x748, is included in the body builder certificate 700, this may mean that the ECU associated with RPM control is a control item authorized to perform the function. The gateway 110 may transmit the body builder certificate 700 to the ECU linked to the CAN ID, 0x748, and may set to permit an RPM control command from the body builder 300.

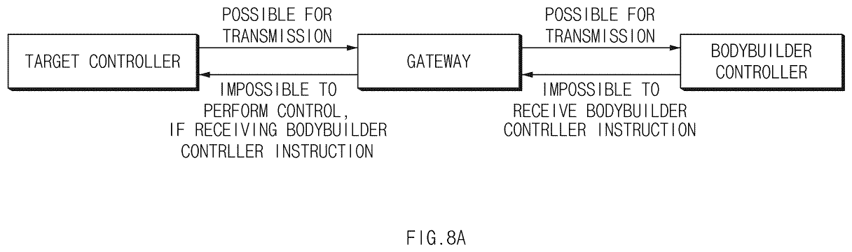

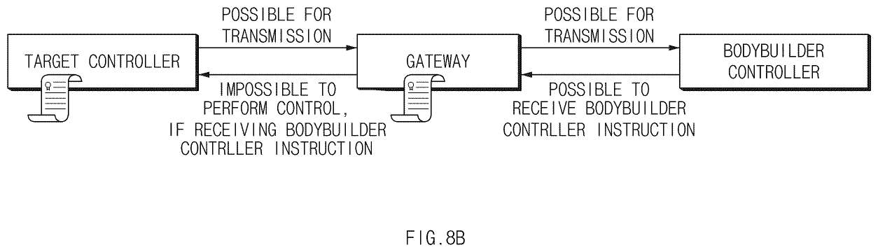

FIGS. 8A and 8B are drawings illustrating a communication flow diagram according to whether there is a body builder certificate, in a body builder control system according to an embodiment of the present disclosure.

Referring to FIG. 8A, because there is no body builder certificate, when receiving an instruction from a gateway, a target controller may fail to perform control based on the received instruction.

Referring to FIG. 8B, FIG. 8B illustrates a process in which a body builder control instruction is transmitted and received via a gateway between the target controller in a vehicle and a body builder controller. The target controller may receive a specific control instruction from a body builder and may implement the instruction. The gateway may perform routing between the target controller and the body builder controller, such that the instruction is securely delivered between the target controller and the body builder controller. The body builder controller may have a transmission function capable of receiving a control instruction from the target controller via the gateway and performing a necessary control task. As a result, it is possible to perform bidirectional communication between the body builder and a vehicle system. Each device may perform reliable control based on a body builder certificate.

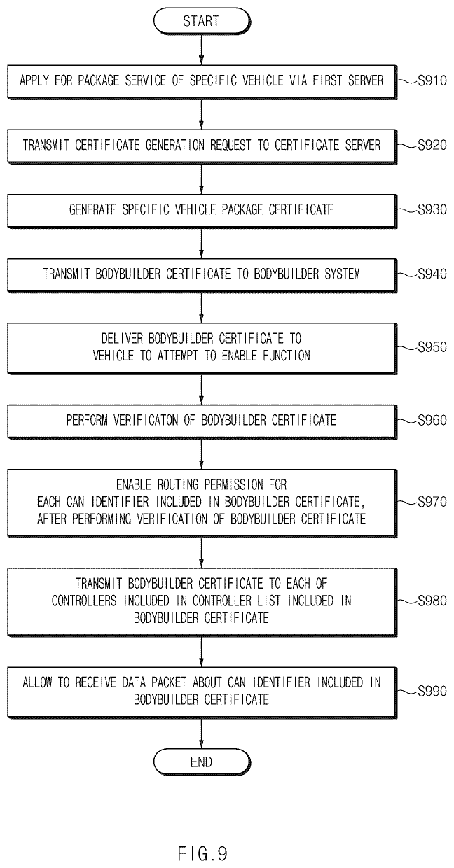

FIG. 9 is a flowchart for describing a body builder control method according to an embodiment of the present disclosure.

Referring to FIG. 9, in an operation S910, a user of a body builder (e.g., a special vehicle owner) may apply for a package service of a specific vehicle via a first server. For example, the user may apply for the package service of the specific vehicle, via the interface shown in FIG. 6.

In an operation S920, the first server may transmit a certificate generation request requested by the user to a second server. The second server may be a certificate server.

In an operation S930, the second server may generate a specific vehicle package certificate (i.e., a body builder certificate). For example, the second server may generate the specific vehicle package certificate and may include i) a CAN identifier to be enabled in the certificate and ii) controller information in the body builder certificate.

In an operation S940, the second server may transmit the generated body builder certificate to the first server. The first server may be a part of, or associated with, a body builder system.

In an operation S950, the first server may deliver the body builder certificate to a vehicle to attempt to enable a function.

In an operation S960, the gateway may perform verification of the body builder certificate received from the first server.

In an operation S970, the gateway may enable routing permission for each CAN identifier included in the body builder certificate, after performing the verification of the body builder certificate.

In an operation S980, the gateway may transmit the body builder certificate to each of controllers included in a controller list included in the body builder certificate.

In an operation S990, a target controller may allow to receive a data packet (or an instruction) associated with a CAN identifier included in the body builder certificate.

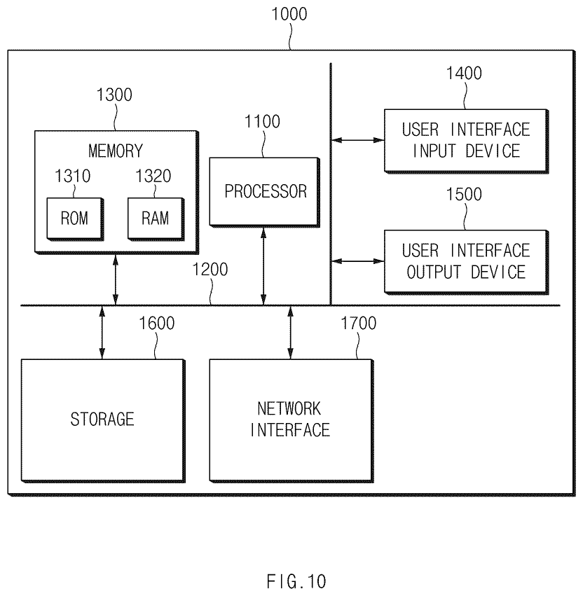

FIG. 10 is a drawing illustrating a computing system associated with a body builder control method according to an embodiment of the present disclosure.

Referring to FIG. 10, a computing system 1000 associated with the body builder control method may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the operations of the method or algorithm described in connection with embodiments of the present disclosure may be directly implemented with a hardware module, a software module, or a combination of the hardware module and the software module, which is executed by the processor 1100. The software module may reside on a storage medium (that is, the memory 1300 and/or the storage 1600) such as a RAM, a flash memory, a ROM, an EPROM, an EEPROM, a register, a hard disc, a removable disk, and a CD-ROM.

The storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

Hereinabove, although the present disclosure has been described with reference to several embodiments and the accompanying drawings, the present disclosure is not limited thereto. Rather, the present disclosure may be variously modified and altered by those having ordinary skill in the art to which the present disclosure pertains without departing from the spirit and scope of the present disclosure claimed in the following claims.

The above-described embodiments may be implemented with hardware components, software components, and/or a combination of hardware components and software components. For example, the devices, methods, and components described in the embodiments may be implemented using general-use computers or special-purpose computers, such as a processor, a controller, an arithmetic logic unit (ALU), a digital signal processor, a microcomputer, a field programmable array (FPGA), a programmable logic unit (PLU), a microprocessor, or any device which may execute instructions and respond. A processing unit may perform an operating system (OS) or a software application running on the OS. Further, the processing unit may access, store, manipulate, process and generate data in response to execution of software. It should be understood by those having ordinary skill in the art that although a single processing unit may be illustrated for convenience of understanding, the processing unit may include a plurality of processing elements and/or a plurality of types of processing elements. For example, the processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively instruct the processing unit. Software and/or data may be permanently or temporarily embodied in any type of machine, component, physical equipment, virtual equipment, computer storage medium or unit or transmitted signal waves so as to be interpreted by the processing unit or to provide instructions or data to the processing unit. Software may be dispersed throughout computer systems connected over networks and be stored or executed in a dispersion manner. Software and data may be recorded in one computer-readable storage media.

The methods according to embodiments may be implemented in the form of program instructions which may be executed through various computer means and may be recorded in computer-readable media. The computer-readable media may include program instructions, data files, data structures, and the like alone or in combination, and the program instructions recorded on the media may be specially designed and configured for an example or may be known to and usable by those having ordinary skill in the art to which the present disclosure pertains. Examples of computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Examples of computer programs include not only machine language codes created by a compiler, but also high-level language codes that are capable of being executed by a computer by using an interpreter or the like.

The above-described hardware devices may be configured to act as one or a plurality of software modules to perform the operations of the embodiments, or vice versa.

Even though the embodiments are described with reference to restricted drawings, it should be apparent to one having ordinary skill in the art that the embodiments may be variously changed or modified based on the above description. For example, adequate effects may be achieved even if the foregoing processes and methods are carried out in different order than described above, and/or the aforementioned components, such as systems, structures, devices, or circuits, are concatenated or coupled in different forms and modes than as described above or be substituted or switched with other components or equivalents.

A description is given below of the effects of the gateway, the body builder control system, and the method thereof according to an embodiment of the present disclosure.

According to at least one embodiment of the present disclosure, the gateway may identify a body builder certificate generated by a second server for controlling a vehicle including the gateway and managing the body builder certificate, based on a certificate generation request of a first server for control of a body builder to ensure secure communication with an external device outside a vehicle and may limit unnecessary access to an internal function of the vehicle to reinforce security and ensure safety of the vehicle and the driver.

In addition, various effects ascertained directly or indirectly through the present disclosure may be provided.

Therefore, other implements, other embodiments, and equivalents to claims are within the scope of the following claims.

Therefore, embodiments of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. A gateway, comprising:
a memory storing computer-executable instructions; and
a processor configured to execute the computer-executable instructions,
wherein the processor is configured to:
receive a body builder certificate generated by a second server configured to control a vehicle that includes the gateway, wherein the body builder certificate is generated based on a certificate generation request of a first server configured to perform control of a body builder;
determine routing based on a control area network (CAN) identifier included in the body builder certificate, based on performing verification of the body builder certificate; and
transmit the body builder certificate to a target controller associated with the CAN identifier, among controllers included in the vehicle.

2. The gateway of claim 1, wherein the processor is configured to:
determine whether the body builder certificate is a certificate generated by the second server, based on receiving the body builder certificate; and
determine whether the target controller, associated with the CAN identifier included in the body builder certificate, is included in the vehicle.

3. The gateway of claim 2, wherein the processor is configured to:
transmit a data packet to the target controller, using routing information obtained from a routing table based on the CAN identifier; and
determine the body builder certificate as a valid certificate, based on receiving an approval request from the target controller.

4. The gateway of claim 1, wherein the processor is configured to:
perform the verification of the body builder certificate, based on determining that the body builder certificate corresponds to the body builder in the vehicle;
transmit the body builder certificate to the target controller, based on determining routing based on the CAN identifier included in the body builder certificate; and
transmit a state data packet received from the target controller to a controller of the body builder.

5. A body builder control system, comprising:
a gateway;
a first server configured to perform control of a body builder; and
a second server configured to control a vehicle that includes the gateway,
wherein the gateway is configured to
receive a body builder certificate generated by the second server, wherein the body builder certificate is generated based on a certificate generation request of the first server,
determine routing based on a control area network (CAN) identifier included in the body builder certificate, based on performing verification of the body builder certificate, and
transmit the body builder certificate to a target controller associated with the CAN identifier, among controllers included in the vehicle.

6. The body builder control system of claim 5, wherein:
the first server is configured to transmit the certificate generation request to the second server to request control of the body builder in the vehicle; and
the second server is configured to
identify a control item included in the certificate generation request, based on receiving the certificate generation request from the first server, and
generate the body builder certificate to include the control item and the CAN identifier associated with the target controller determined based on the control item.

7. The body builder control system of claim 6, wherein the second server is configured to:
perform digital signature and encryption of the body builder certificate; and
transmit the body builder certificate, the digital signature and the encryption of which are performed, to the first server.

8. The body builder control system of claim 7, wherein the first server is configured to:
receive the body builder certificate generated by the second server; and
apply the body builder certificate to a controller of the body builder, such that the body builder certificate is transmitted to the gateway at a time point when the body builder is mounted on the vehicle.

9. A body builder control method, comprising:
receiving a body builder certificate generated by a second server, wherein the body builder certificate is generated based on a certificate generation request of a first server;
determining routing based on a control area network (CAN) identifier included in the body builder certificate, based on performing verification of the body builder certificate; and
transmitting the body builder certificate to a target controller associated with the CAN identifier, among controllers included in a vehicle.

10. The body builder control method of claim 9, wherein determining routing based on the CAN identifier includes:
determining whether the body builder certificate is a certificate generated by the second server, based on receiving the body builder certificate; and
determining whether the target controller, associated with the CAN identifier included in the body builder certificate, is included in the vehicle.

11. The body builder control method of claim 10, wherein determining routing based on the CAN identifier further includes:
transmitting a data packet to the target controller, using routing information obtained from a routing table based on the CAN identifier; and
determining the body builder certificate as a valid certificate, based on receiving an approval request from the target controller.

12. The body builder control method of claim 9, wherein determining routing based on the CAN identifier includes:
performing the verification of the body builder certificate, based on determining that the body builder certificate corresponds to a body builder in the vehicle;
transmitting the body builder certificate to the target controller, based on determining routing based on the CAN identifier included in the body builder certificate; and
transmitting a state data packet received from the target controller to a controller of the body builder.

13. The body builder control method of claim 9, further comprising:
transmitting the certificate generation request to the second server to request control of a body builder in the vehicle;
identifying, by the second server, a control item included in the certificate generation request, based on receiving the certificate generation request from the first server; and
generating, by the second server, the body builder certificate to include the control item and the CAN identifier associated with the target controller based on the control item.

14. The body builder control method of claim 13, further comprising:
performing digital signature and encryption of the body builder certificate by the second server; and
transmitting the body builder certificate, the digital signature and the encryption of which are performed, to the first server.

15. The body builder control method of claim 14, further comprising:
receiving, by the first server, the body builder certificate generated by the second server; and
applying the body builder certificate to a controller of the body builder, such that the body builder certificate is transmitted to a gateway at a time point when the body builder is mounted on the vehicle.
